(19) United States
(12) Patent Application Publication
(10) Pub. No.: US 2017/0168807 A1
(43) Pub. Date: Jun. 15, 2017

(54) METHOD AND ELECTRONIC DEVICE FOR UPDATING APPLICATION PROGRAM

(71) Applicants: Le Holdings (Beijing) Co., Ltd., Beijing (CN); LeCloud Computing Co., Ltd., Beijing (CN)

(72) Inventor: Ang LI, Beijing (CN)

(21) Appl. No.: 15/357,650

(22) Filed: Nov. 21, 2016

Related U.S. Application Data
(63) Continuation of application No. PCT/CN2016/097215, filed on Aug. 29, 2016.

(30) Foreign Application Priority Data
Dec. 14, 2015 (CN) 201510923461.0

(51) Int. Cl. G06F 9/445

(52) U.S. Cl. CPC G06F 8/65

(57) ABSTRACT

Disclosed are a method and an electronic device for updating an application program. The method includes: receiving implementation module updating information sent by a server, wherein the implementation module updating information carries an implementation module plugin needing to be updated in the application program; loading the implementation module plugin according to a base interface in a local application program, wherein the base interface comprises a plurality of functional interfaces, and different functional interfaces correspond to different implementation module plugins; and updating a corresponding implementation module plugin in the local application program by means of the implementation module plugin.

### CROSS REFERENCE TO RELATED APPLICATIONS

This application is a continuation of International Application No. PCT/CN2016/097215, filed on Aug. 29, 2016, which is based upon and claims priority to Chinese Patent Application No. 201510923461.0, filed on Dec. 14, 2015, the entire contents of which are incorporated herein by reference.

### TECHNICAL FIELD

The disclosure relates to information technologies, and more particularly, to a method and an electronic device for updating an application program.

### BACKGROUND

With rapid development of mobile Internet and constant improvement of mobile terminal intellectualized technologies, massive application programs are downloaded and installed by mobile terminals, which greatly enriches people's mobile life. To meet people's daily increasing demands, developers generally add new functional logics to application programs developed by them at irregular intervals to improve or optimize the application programs. If users can timely use application programs of the latest versions, they may most timely feel convenience and service improvement brought about by upgrade and update of the application programs, and correspondingly they may feel use experiences improved.

At present, when a module in an application program is updated, the whole application program needs to be updated, and when the application program is updated, update notification information needs to be sent to users. However, an application program includes a plurality of modules, the whole application program needs to be updated every time when a module is updated, when a plurality of modules need to be updated, number of times in updating the application program may be large, and it is required to frequently send update notifications to users when a plurality of modules are updated, which may bother the users. Therefore, existing application programs are lower in update efficiency and poorer in user experience.

### SUMMARY

The present disclosure provides a method and an electronic device for updating an application program to solve a problem of lower efficiency and poorer user experience in updating existing application programs.

In a first aspect, embodiments of the present disclosure provide a method for updating an application program, applied to a terminal and including:

receiving implementation module updating information sent by a server, where the implementation module updating information carries an implementation module plugin needing to be updated in the application program;

loading the implementation module plugin according to a base interface in a local application program, where the base interface includes a plurality of functional interfaces, and different functional interfaces correspond to different implementation module plugins; and

updating a corresponding implementation module plugin in the local application program by means of the implementation module plugin.

In a second aspect, embodiments of the present disclosure further provide an electronic device, including: at least one processor; and a memory communicably connected with the at least one processor for storing instructions executable by the at least one processor, wherein execution of the instructions by the at least one processor causes the at least one processor to perform any methods for updating an application program mentioned by embodiments of the present disclosure.

In a third aspect, embodiments of the present disclosure further provide a non-transitory computer-readable storage medium storing executable instructions, wherein the executable instructions are configured to perform any methods for updating an application program mentioned by embodiments of the present disclosure.

In a fourth aspect, embodiments of the present disclosure further provide a computer program product, the computer program product comprising a computer program stored on a non-transitory computer-readable storage medium, the computer program comprising program instructions which, when executed on a computer, causes the computer to perform any methods for updating an application program mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for updating an application program in accordance with some embodiments;

FIG. 2 is a flowchart of another method for updating an application program in accordance with some embodiments;

FIG. 3 is a structural block diagram of an apparatus for updating an application program in accordance with some embodiments;

FIG. 4 is a structural block diagram of another apparatus for updating an application program in accordance with some embodiments; and

FIG. 5 is a schematic diagram of a hardware structure of an electronic device performing the method for updating an application program in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure.

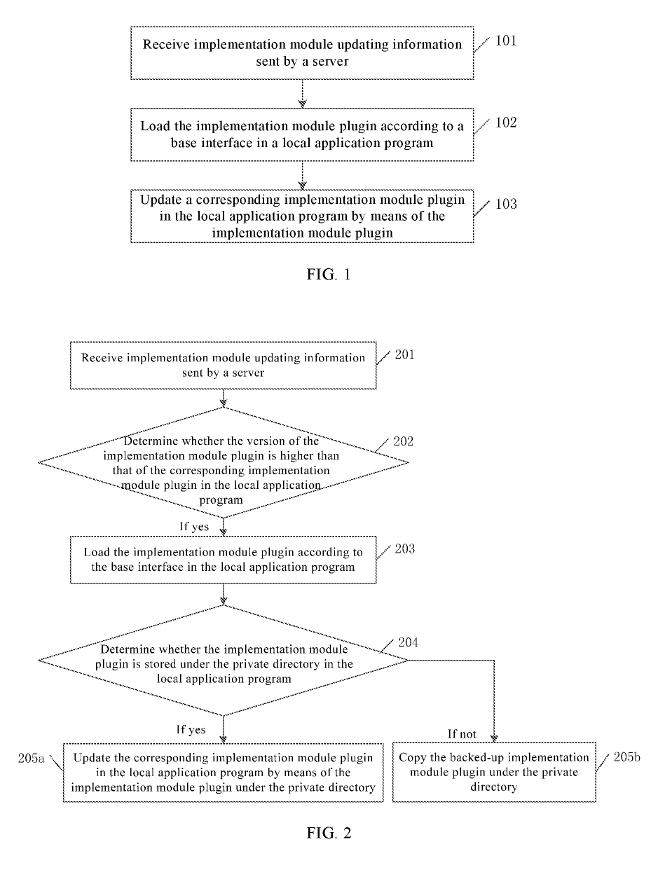

Embodiments of the present disclosure provide a method for updating an application program, as shown in FIG. 1, the method specifically includes following steps.

101: Implementation module updating information sent by a server is received.

The implementation module updating information carries an implementation module plugin needing to be updated in the application program, where the implementation module plugin is a function implementation part in the application program. The implementation module plugin includes a proxy class, an entity class behind the method for really working and the method. The implementation module plugin exits in the form of a standalone unit file and needs to be dynamically loaded when in use. The implementation module plugin can be optionally replaced in the application program, and change of a function thereof does not affect change of an access mode thereon by the application program. It is to be noted that regarding to the application program, what is needed is nothing but to partly integrate the implementation module plugin and an interface of the implementation module plugin into the application program.

102: The implementation module plugin is loaded according to a base interface in a local application program.

The base interface includes a plurality of functional interfaces, and different functional interfaces correspond to different implementation module plugins. The base interface needs all classes and methods provided to outside. The classes and methods in the base interface are some proxy classes or abstract methods, not including concrete implementation. A majority of logics in the base interface will not change except for larger version update. In this case, it is necessary to make modification take effect by integrating to the application program instead of using automatic update. In the embodiments of the present disclosure, the base interface can be available for managing and loading the implementation module plugin.

For example, a LeTV CDE plug-in module integrates functions such as video data transmission and player, and a LeTV video application program needs to integrate this module to acquire and play video data. The LeTV video application program separates a playback function of the CDE into a functional interface and an implementation module plugin, where the functional interface is provided to LeTV Video for use, during a concrete implementation, video data are acquired and videos are played by invoking the implementation module plugin of the CDE, and when new coding-decoding technologies are applied to the player function, the latest implementation module plugin can be automatically acquired through the base interface; whereas the LeTV video application program can use the latest technologies without any operation.

103: A corresponding implementation module plugin in the local application program is updated by means of the implementation module plugin.

In the embodiments of the present disclosure, after the implementation module plugin is successfully loaded, a corresponding implementation module plugin in the local application program is updated by means of the implementation module plugin. In this way, automatic update of the application program can be achieved. It is to be noted that based on characteristics of an Android system and a Software Development Kit (SDK) and by using related technologies such as a reflection technology in Java and a proxy pattern in a design pattern or the like, the present disclosure implements automatic update of an application program in the Android system.

To the embodiments of the present disclosure, when updating the application program, an application developer using or integrating a plugin needs to perform data interaction according to the base interface and the implementation module plugin, both a life cycle and an updating management of the implementation module plugin are managed by the base interface without intervention by a user, namely it is unnecessary to send application program updating information to the user when updating the program, and when a plurality of implementation module plugins in the application program need to be updated, the plurality of implementation module plugins can be updated simultaneously. Therefore, through the embodiments of the present disclosure, efficiency in updating an application program and user experience in updating the application program can be improved.

Corresponding to the foregoing method, embodiments of the present disclosure further provide a method for updating an application program, as shown in FIG. 2, the method specifically includes following steps.

201: Implementation module updating information sent by a server is received.

The implementation module updating information carries an implementation module plugin needing to be updated in the application program. The implementation module plugin is a function implementation part in the application program. The implementation module plugin includes a proxy class, an entity class behind the method for really working and the method. The implementation module plugin exits in the form of a standalone unit file and needs to be dynamically loaded when in use. The implementation module plugin can be optionally replaced in the application program, and change of a function therein does not affect change of an access mode thereon by the application program. It is to be noted that regarding to the application program, what is needed is nothing but to partly integrate the implementation module plugin and an interface of the implementation module plugin into the application program.

202: It is determined whether the version of the implementation module plugin is higher than that of the corresponding implementation module plugin in the local application program.

In the embodiments of the present disclosure, by determining whether the version of the implementation module plugin is higher than that of the corresponding implementation module plugin in the local application program, it can be known whether the corresponding implementation module plugin in the local application program is the latest version. The implementation module plugin can be updated if the corresponding implementation module plugin in the local application program is not the latest version; or otherwise, the local application program has been updated if the corresponding implementation module plugin in the local application program is the latest version, and thus is unnecessary to be updated. For example, if the version of the implementation module plugin is LeTV CDE6.3.7 and the version of the corresponding implementation module plugin in the local application program is LeTV CDE6.3.5, it is determined that the version of the implementation module plugin is higher than that of the corresponding implementation module plugin in the local application program.

203: The implementation module plugin is loaded according to the base interface in the local application program if the version of the implementation module plugin is higher than that of the corresponding implementation module plugin in the local application program.

The base interface includes a plurality of functional interfaces, and different functional interfaces correspond to different implementation module plugins. In the embodiments of the present disclosure, when the version of the implementation module plugin is higher than that of the corresponding implementation module plugin in the local application program, the implementation module plugin is loaded according to the base interface in the local application program. In this way, it can be implemented that only an application program whose version is lower than that of the implementation module plugin is updated, thereby reducing number of times in updating the application program and saving system resources through the embodiments of the present disclosure.

To the embodiments of the present disclosure, after the loading the implementation module plugin according to a base interface in a local application program, the method further includes: storing the implementation module plugin under a private directory in the local application program; and backing up the implementation module plugin. It is to be noted that only by storing the implementation module plugin under the private directory in the local application program can the corresponding implementation module plugin in the application program be updated. The implementation module plugin is backed up in order to solve a problem that the implementation module plugin needs to be reloaded after an application program remover in a terminal device removes the implementation module plugin stored under the private directory.

204: It is determined whether the implementation module plugin is stored under the private directory in the local application program.

205a: The corresponding implementation module plugin in the local application program is updated by means of the implementation module plugin under the private directory if the implementation module plugin is stored under the private directory in the local application program.

205b: The backed-up implementation module plugin is copied under the private directory if the implementation module plugin is not stored under the private directory in the local application program.

Step 205b is a parallel step of Step 205a, if the implementation module plugin stored under the private directory in the local application program is removed by the application program remover in the terminal device, the backed up implementation module plugin is directly copied under the private directory. In this way, both time for reloading the implementation module plugin and network resources used for loading the implementation module plugin can be saved. In the embodiments of the present disclosure, after the backed up implementation module plugin is copied under the private directory, the corresponding implementation module plugin in the local application program is updated according to the implementation module plugin under the private directory.

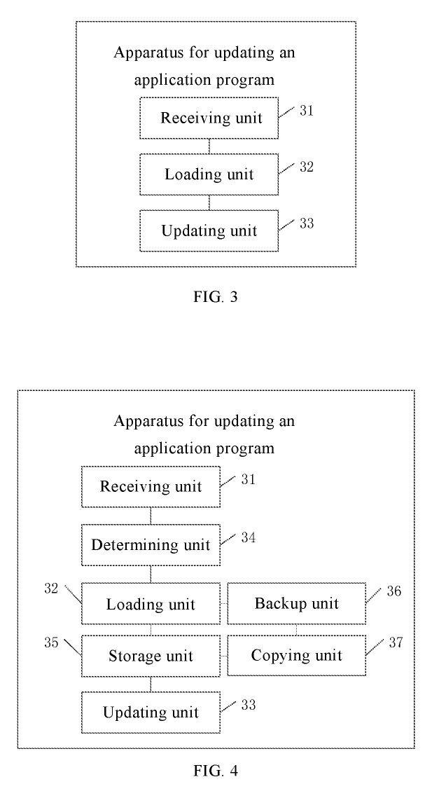

Further, as an implementation of the foregoing method, embodiments of the present disclosure provide an apparatus for updating an application program, as shown in FIG. 3, the apparatus includes: a receiving unit, a loading unit and an updating unit.

The receiving unit 31 is configured to receive implementation module updating information sent by a server, where the implementation module updating information carries an implementation module plugin needing to be updated in the application program. The receiving unit 31 faces to the server. The implementation module plugin is a function implementation part in the application program. The implementation module plugin includes a proxy class, an entity class behind the method for really working and the method. The implementation module plugin exits in the form of a standalone unit file and needs to be dynamically loaded when in use. The implementation module plugin can be optionally replaced in the application program, and change of a function therein does not affect change of an access mode thereon by the application program.

The loading unit 32 is configured to load the implementation module plugin received by the receiving unit 31 according to a base interface in a local application program, where the base interface includes a plurality of functional interfaces, different functional interfaces correspond to different implementation module plugins, and the base interface can be configured to manage and load the implementation module plugin.

The updating unit 33 is configured to update a corresponding implementation module plugin in the local application program by means of the implementation module plugin loaded by the loading unit 32.

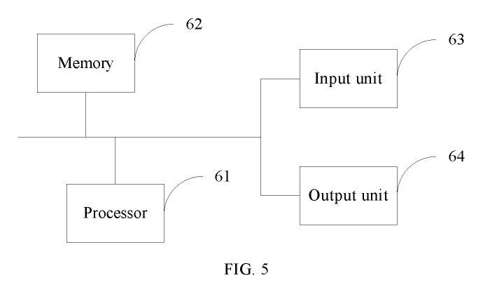

Further, as shown in FIG. 4, the implementation module updating information in the receiving unit 31 further includes a version of an implementation module plugin needing to be updated, and the apparatus further includes: a determining unit 34.

The determining unit 34 is configured to determine whether the version of the implementation module plugin received by the receiving unit 31 is higher than that of the corresponding implementation module plugin in the local application program. It can be learned whether the corresponding implementation module plugin in the local application program is the latest version by determining, by the determining unit 34, whether the version of the implementation module plugin is higher than that of the corresponding implementation module plugin in the local application program.

The loading unit 32 is specifically configured to load the implementation module plugin according to the base interface in the local application program if the version of the implementation module plugin received by the receiving unit 31 is higher than that of the corresponding implementation module plugin in the local application program.

Further, the apparatus further includes:

a storage unit 35, configured to store the implementation module plugin loaded by the loading unit 32 under a private directory in the local application program, where the corresponding implementation module plugin in the application program cannot be updated unless the implementation module plugin is stored under the private directory in the local application program; and

a backup unit 36, configured to back up the implementation module plugin loaded by the loading unit 32. The implementation module plugin is backed up by the backup unit 36 in order to solve a problem that the implementation module plugin needs to be reloaded after an application program remover in a terminal device removes the implementation module plugin stored under the private directory.

The determining unit 34 is further configured to determine whether the implementation module plugin stored by the storage unit 35 is stored under the private directory in the local application program.

The updating unit 36 is specifically configured to update a corresponding implementation module plugin in the local application program by means of the implementation module plugin under the private directory if the implementation module plugin stored by the storage unit 35 is stored under the private directory in the local application program.

Further, the apparatus further includes:

a copying unit 37, configured to copy the implementation module plugin backed up by the backup unit 36 under the private directory if the implementation module plugin stored by the storage unit 35 is not stored under the private directory in the local application program. The implementation module plugin backed up by the backup unit 36 is copied under the private directory by the copying unit 37, which can save time for reloading the implementation module plugin and network resources used for loading the implementation module plugin.

In conclusion, according to a method and an apparatus for updating an application program provided by the embodiments of the present disclosure, first of all, implementation module updating information sent by a server is received, where the implementation module updating information carries an implementation module plugin needing to be updated in the application program; then the implementation module plugin is loaded according to a base interface in a local application program, where the base interface includes a plurality of functional interfaces, and different functional interfaces correspond to different implementation module plugins; and finally a corresponding implementation module plugin in the local application program is updated by means of the implementation module plugin. Compared with a fact that at present the whole application program needs to be updated when a module in the application program is updated and update notification information needs to be sent to a user when updating the application program, in the embodiments of the present disclosure, when an implementation module plugin in the application program is to be updated, the server first sends the implementation module updating information to a client, after receiving the information, the client loads the implementation module plugin through a base interface in a local application program, and then updates a corresponding implementation module plugin in the local application program according to the implementation module plugin. Both a life cycle and an updating management of the implementation module plugin are completely managed by the implementation module plugin itself without intervention by the user, and when a plurality of implementation module plugins need to be updated, the implementation module plugins can be updated simultaneously, and the updating of the application program can be achieved by updating the implementation module plugins. Therefore, through the embodiments of the present disclosure, efficiency in updating an application program and user experience in updating the application program can be improved.

It is to be noted that in allusion to the foregoing apparatus for updating an application program, functions of each unit module used in the embodiments of the present disclosure can be implemented through a hardware processor.

FIG. 5 is a block diagram of an electronic device which is configured to perform the methods for updating an application program according to an embodiment of the present disclosure. As shown in FIG. 5, the device includes:

one or more processors 61 and memory 62. A processor 61 is showed in FIG. 5 for an example.

Device which is configured to perform the methods for updating an application program can also include: input unit 63 and output unit 64.

Processor 61, memory 62, input unit 63 and output unit 64 can be connected by BUS or other methods, and BUS connecting is showed in FIG. 5 for an example.

The processor 61 can invoke logic instructions in the memory 62 to execute the following method: implementation module updating information sent by a server is received, where the implementation module updating information carries an implementation module plugin needing to be updated in the application program; the implementation module plugin is loaded according to a base interface in a local application program, where the base interface includes a plurality of functional interfaces, and different functional interfaces correspond to different implementation module plugins; and a corresponding implementation module plugin in the local application program is updated by means of the implementation module plugin.

Memory 62 can be used for storing non-transitory software program, non-transitory computer executable program and modules as a non-transitory computer-readable storage medium, such as corresponding program instructions/modules for the methods for updating an application program mentioned by embodiments of the present disclosure (such as shown in FIG. 3, receiving unit 31, loading unit 32 and updating unit 33). Processor 61 performs kinds of functions and updating an application program of the electronic device by executing non-transitory software program, instructions and modules which are stored in memory 62, thereby realizes the methods for updating an application program mentioned by embodiments of the present disclosure.

Memory 62 can include program storage area and data storage area, thereby the operating system and applications required by at least one function can be stored in program storage area and data created by using the device for updating an application program can be stored in data storage area. Furthermore, memory 62 can include high speed Random-access memory (RAM) or non-volatile memory such as magnetic disk storage device, flash memory device or other non-volatile solid state storage devices. In some embodiments, memory 62 can include long-distance setup memories relative to processor 61, which can communicate with the device for updating an application program by networks. The examples of said networks are including but not limited to Internet, Intranet, LAN, mobile Internet and their combinations.

Input unit 63 can be used to receive inputted number, character information and key signals causing user configures and function controls of the device for updating an application program. Output unit 64 can include a display screen or a display device.

The said module or modules are stored in memory 62 and perform the methods for updating an application program when executed by one or more processors 61.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

Further, an embodiment of the present disclosure further provides a non-transitory computer-readable storage medium storing executable instructions, wherein the executable instructions are configured to perform any methods for updating an application program mentioned by embodiments of the present disclosure.

Finally, it should be noted that, persons of ordinary skill in the art can understand that all or part of the steps in each method according to the embodiments of the present disclosure may be implemented by a program instructing relevant hardware, and the program may be stored in a computer-readable storage medium. When the program is run, steps of each method according to the embodiments of the present disclosure are performed. The storage medium may be a magnetic disk, an optical disk, a read-only memory (ROM), a random access memory (RAM), and so on.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for updating an application program, applied to a terminal, comprising:
receiving implementation module updating information sent by a server, wherein the implementation module updating information carries an implementation module plugin needing to be updated in the application program;
loading the implementation module plugin according to a base interface in a local application program, wherein the base interface comprises a plurality of functional interfaces, and different functional interfaces correspond to different implementation module plugins; and
updating a corresponding implementation module plugin in the local application program by means of the implementation module plugin.

2. The method according to claim 1, wherein the implementation module updating information further comprises a version of an implementation module plugin needing to be updated, and before the loading the implementation module plugin according to a base interface in a local application program, the method further comprises:
determining whether the version of the implementation module plugin is higher than that of the corresponding implementation module plugin in the local application program; and
the loading the implementation module plugin according to a base interface in a local application program comprises:
loading the implementation module plugin according to the base interface in the local application program if the version of the implementation module plugin is higher than that of the corresponding implementation module plugin in the local application program.

3. The method according to claim 2, wherein after the loading the implementation module plugin according to a base interface in a local application program, the method further comprises:
storing the implementation module plugin under a private directory in the local application program; and
backing up the implementation module plugin.

4. The method according to claim 3, wherein before the updating a corresponding implementation module plugin in the local application program by means of the implementation module plugin, the method further comprises:
determining whether the implementation module plugin is stored under the private directory in the local application program; and
the updating a corresponding implementation module plugin in the local application program by means of the implementation module plugin comprises:
updating a corresponding implementation module plugin in the local application program by means of the implementation module plugin under the private directory if the implementation module plugin is stored under the private directory in the local application program.

5. The method according to claim 4, wherein after the determining whether the implementation module plugin is stored under the private directory in the local application program, the method further comprises:
copying the backed-up implementation module plugin under the private directory if the implementation module plugin is not stored under the private directory in the local application program.

6. An electronic device, comprising:
at least one processor;
and a memory communicably connected with the at least one processor for storing instructions executable by the at least one processor, wherein execution of the instructions by the at least one processor causes the at least one processor to:
receive implementation module updating information sent by a server, wherein the implementation module updating information carries an implementation module plugin needing to be updated in the application program;
load the implementation module plugin according to a base interface in a local application program, wherein the base interface comprises a plurality of functional interfaces, and different functional interfaces correspond to different implementation module plugins; and
update a corresponding implementation module plugin in the local application program by means of the implementation module plugin.

7. The electronic device according to claim 6, wherein the implementation module updating information further comprises a version of an implementation module plugin needing to be updated, and before the loading the implementation module plugin according to a base interface in a local application program, the instructions are executed to cause the at least one processor to:
determine whether the version of the implementation module plugin is higher than that of the corresponding implementation module plugin in the local application program; and
the loading the implementation module plugin according to a base interface in a local application program comprises:
loading the implementation module plugin according to the base interface in the local application program if the version of the implementation module plugin is higher than that of the corresponding implementation module plugin in the local application program.

8. The electronic device according to claim 7, wherein after the loading the implementation module plugin according to a base interface in a local application program, the instructions are executed to cause the at least one processor to:
store the implementation module plugin under a private directory in the local application program; and
back up the implementation module plugin.

9. The electronic device according to claim 8, wherein before the updating a corresponding implementation module plugin in the local application program by means of the implementation module plugin, the instructions are executed to cause the at least one processor to:
determine whether the implementation module plugin is stored under the private directory in the local application program; and
the updating a corresponding implementation module plugin in the local application program by means of the implementation module plugin comprises:
updating a corresponding implementation module plugin in the local application program by means of the implementation module plugin under the private directory if the implementation module plugin is stored under the private directory in the local application program.

10. The electronic device according to claim 9, wherein after the determining whether the implementation module plugin is stored under the private directory in the local application program, the instructions are executed to cause the at least one processor to:
copy the backed-up implementation module plugin under the private directory if the implementation module plugin is not stored under the private directory in the local application program.

11. A non-transitory computer-readable storage medium storing executable instructions that, when executed by an electronic device, cause the electronic device to:
receive implementation module updating information sent by a server, wherein the implementation module updating information carries an implementation module plugin needing to be updated in the application program;
load the implementation module plugin according to a base interface in a local application program, wherein the base interface comprises a plurality of functional interfaces, and different functional interfaces correspond to different implementation module plugins; and
update a corresponding implementation module plugin in the local application program by means of the implementation module plugin.

12. The non-transitory computer-readable storage medium according to claim 11, wherein the implementation module updating information further comprises a version of an implementation module plugin needing to be updated, and before the loading the implementation module plugin according to a base interface in a local application program, the executable instructions are executed to cause the electronic device to:
determine whether the version of the implementation module plugin is higher than that of the corresponding implementation module plugin in the local application program; and
the loading the implementation module plugin according to a base interface in a local application program comprises:
loading the implementation module plugin according to the base interface in the local application program if the version of the implementation module plugin is higher than that of the corresponding implementation module plugin in the local application program.

13. The non-transitory computer-readable storage medium according to claim 12, wherein after the loading the implementation module plugin according to a base interface in a local application program, the executable instructions are executed to cause the electronic device to:
store the implementation module plugin under a private directory in the local application program; and
back up the implementation module plugin.

14. The non-transitory computer-readable storage medium according to claim 13, wherein before the updating a corresponding implementation module plugin in the local application program by means of the implementation module plugin, the executable instructions are executed to cause the electronic device to:
determine whether the implementation module plugin is stored under the private directory in the local application program; and
the updating a corresponding implementation module plugin in the local application program by means of the implementation module plugin comprises:
updating a corresponding implementation module plugin in the local application program by means of the implementation module plugin under the private directory if the implementation module plugin is stored under the private directory in the local application program.

15. The non-transitory computer-readable storage medium according to claim 14, wherein after the determining whether the implementation module plugin is stored under the private directory in the local application program, the executable instructions are executed to cause the electronic device to:
copy the backed-up implementation module plugin under the private directory if the implementation module plugin is not stored under the private directory in the local application program.
